(19) United States
(12) Patent Application Publication
(10) Pub. No.: US 2009/0228686 A1
(43) Pub. Date: Sep. 10, 2009

(54) Energy efficient processing device

(76) Inventors: Steven E. Koenck, Cedar Rapids, IA (US); John K. Gee, Mount Vernon, IA (US); Jeffrey D. Russell, Marion, IA (US); Allen P. Mass, Lisbon, IA (US)

Correspondence Address: FOLEY & LARDNER LLP, 777 EAST WISCONSIN AVENUE, MILWAUKEE, WI, 53202-5306, US

(21) Appl. No.: 11/805,510

(22) Filed: May 22, 2007

(51) Int. Cl. G06F 15/76

(52) U.S. Cl. 712/32; 712/E09.004

(57) ABSTRACT

A network processor with a high performance in computing throughput, size and power density for use in applications such as Software Defined Radio (SDR) mesh topology. The network processor uses a core architecture comprised of a programmable microcoded sequencer to implement state management and control, a data manipulation subsystem controlled by fully decoded microinstructions. To save power, the core architecture employs a fully decoded microcoded control unit, multiplexer based register select/write logic, between 10000 to 20000 gates, a power consumption of less than 10 mW.

### CROSS-REFERENCE TO RELATED APPLICATIONS

This application is filed concurrently with commonly assigned, non-provisional U.S. patent applications U.S. patent application Ser. No. (to be assigned), entitled “IMPROVED MOBILE NODAL BASED COMMUNICATION SYSTEM, METHOD AND APPARATUS” listing as inventors Steven E. Koenck, Allen P. Mass, James A. Marek, John K. Gee and Bruce S. Kloster, having docket number Rockwell Collins 06-CR-00507; and, U.S. patent application Ser. No. (to be assigned), “SYSTEM AND METHOD FOR LARGE MICROCODED PROGRAMS” listing as inventors Steven E. Koenck and John K. Gee, having docket number Rockwell Collins 06-CR-00535; all incorporated by reference herein.

### BACKGROUND OF THE INVENTION

1. Field of Invention

The present invention relates generally to the field of processing devices, and in particular to an energy efficient processing device.

2. Description of Related Art

The present invention relates generally to a processing device. Conventional processing devices may include microprocessors, microcontrollers or digital signal processors. In computer engineering, microarchitecture is the design and layout of a microprocessor, microcontroller, or digital signal processor. Microarchitecture considerations include overall block design, such as the number of execution units, the type of execution units (e.g. floating point, integer, branch prediction), the nature of the pipelining, cache memory design, and peripheral support.

Microcode is the microprogram that implements a CPU instruction set. A computer operation is an operation specified by an instruction stored in binary, in a computer's memory. A control unit in the computer, uses the instruction (e.g. operation code, or opcode), and decodes the opcode and other bits in the instruction to perform required microoperations. Decoding of the opcode increases the latency of the execution of an instruction. The control store, a memory, contains the CPU's microprogram, and is accessed by a microsequencer. Microoperations are implemented by hardware, often involving combinational circuits. In a CPU, a control unit is said to be hardwired when the control logic expressions are directly implemented with logic gates or in a PLA (programmable logic array). In contrast to this hardware approach for the control logic expressions, a more flexible software approach may be employed where in a microprogrammed control unit, the control signals to be generated at a given time step are stored together in a control word, called a microinstruction. The collection of these microinstructions is the microprogram, and the microprograms are stored in a memory element termed the control store.

Thus the outputs of the control unit direct the CPU operations, and a control unit can be thought of as a finite state machine. Today control units are not so much hardwired as implemented as a microprogram that is stored in the control store. Words of the microprogram are selected by a microsequencer and the bits from those words directly control the different parts of the device, including the registers, arithmetic and logic units, instruction registers, buses, and off-chip input/output. In modern computers, each of these subsystems may itself have its own subsidiary controller, with the control unit acting as a supervisor.

All types of control units generate electronic control signals that control other parts of a CPU. Control units are usually one of these two types: microcoded control units or hardware control units. In a microcoded control unit, a program reads signals, and generates control signals. The program itself is executed by a simple digital circuit called a microsequencer. In a hardware control unit, a digital circuit generates the control signals directly.

Hence microprogramming is a systematic technique for implementing the control unit of a computer via a microcoded control unit. Microprogramming is a form of stored-program logic that substitutes for sequential-logic control circuitry. A microinstruction is an instruction that controls data flow and instruction-execution sequencing in a processor at a more fundamental level than machine instructions; thus, a series of microinstructions is necessary to perform an individual machine instruction.

A central processing unit (CPU) in a computer system is generally composed into a data path unit and a control unit, with the control unit directing the data path unit. The data path unit or datapath includes registers, function units such as ALUs (arithmetic logic units), shifters, interface units for main memory and I/O, RAM, including scratchpad RAM, and internal busses. Scratchpad RAM is a memory cache reserved for direct and private usage by the CPU. A cache is used to temporarily store copies of data that reside in slower main memory.

The control unit controls the steps taken by the data path unit during the execution of a machine instruction, microinstruction or macroinstruction (e.g., load, add, store, conditional branch) by the datapath. Each step in the execution of a macroinstruction is a transfer of information within the data path, possibly including the transformation of data, address, or instruction bits by the function units. The transfer is often a register transfer and is accomplished by sending a copy of (i.e. gating out) register contents onto internal processor busses, selecting the operation of ALUs, shifters, and the like, and receiving (i.e., gating in) new values for registers. Control signals consist of enabling signals to gates that control sending or receiving of data at the registers, termed control points, and operation selection signals. The control signals identify the microoperations required for each register transfer and are supplied by the control unit. A complete macroinstruction is executed by generating an appropriately timed sequence of groups of control signals, with the execution termed the microoperation.

A complex instruction set computer (CISC) is a microprocessor instruction set architecture (ISA) in which each instruction can execute several low-level operations, such as a load from memory, an arithmetic operation, and a memory store, all in a single instruction, and from within the CPU. The ISA specifies the instructions, their binary formats, the complete effect of each operation in a CPU, the visible registers of the machine, and any other aspects of the system that affect how it is programmed. The term CISC was coined to contrast to the ISA for a reduced instruction set computer (RISC). Before the RISC processors were designed, many computer architects designed instruction sets to support high-level programming languages by providing “high-level” instructions such as procedure call and return, loop instructions such as “decrement and branch if non-zero” and complex addressing modes, to allow data structure and array accesses to be combined into a single instruction. An example of a CISC CPU is the Intel iAPX 432 microprocessor design, which supported object-oriented programming in hardware, even providing for automatic garbage collection for deallocated objects in memory. The iAPX architecture was so complex for its time that it had to fit on multiple chips. Another example is the Intel x86 microprocessor, used in current personal computers. Further, Directly Executable High Level Language (Directly Executable HHL) design CPUs can take a high level language and directly execute it by microcode, without compilation. The IBM Future Systems project and Data General Fountainhead Processor are examples of Directly Executable HHL design.

The compact nature of the CISC ISA results in smaller program sizes and fewer calls to main memory. A control store (fast memory within the CPU) is often prominent in a CISC design, and a CISC CPU will lack the decoding logic stage found in a RISC CPU.

A Very Long Instruction Word (VLIW) architecture refers to a CPU architectural approach to take advantage of instruction level parallelism. In Very Long Instruction Word CPUs, many statically scheduled, tightly coupled, fine-grained operations execute in parallel within a single instruction stream. A processor that executes different sub-steps of sequential instructions simultaneously (pipelining), that employs parallel (superscalar) execution and that executes instructions out of order (branch prediction) can achieve significant performance improvements, at the cost of increased hardware complexity. The VLIW approach offers benefits similar to these techniques but employs a compiler to determine which operations may be executed in parallel, and which branch is most likely to be executed, during compiling of a computer program. VLIW architectures therefore may offer improved computational power with less hardware, at the cost of greater compiler complexity. One VLIW instruction may encode multiple operations; with one instruction operation for each execution unit of the device. For example, if a VLIW CPU has three execution units, then a VLIW instruction for that chip would have three operation fields, each field specifying what operation should be done on that corresponding execution unit. To accommodate these operation fields, VLIW instructions are usually at least 64 bits in width, and on some architectures wider.

As stated, a reduced instruction set computer, or RISC, is a microprocessor instruction set architecture (ISA) that favors a simpler set of reduced instructions. The idea was originally inspired by the discovery that many instructions in CISC CPU architectures were ignored by the programs that were running on them. Also these more complex features took several processor cycles to be performed. Additionally, the performance gap between the processor and main memory was increasing. This led to a number of techniques to streamline processing within the CPU, while at the same time attempting to reduce the total number of memory accesses. A RISC microprocessor utilizes and emphasizes a decoding logic stage rather than emphasizing a control store, as in a CISC chip. In addition, the term “Load-Store” is often used to describe RISC processors. Instead of the CPU handling many addressing modes, load-store architecture uses a separate unit dedicated to handling very simple forms of load and store operations, and only register-to-register operations are allowed. By contrast, CISC processors are termed “register-memory” or “memory-memory”. Thus RISC compilers keep operands in registers (the operand being the part of a machine instruction that references data or a peripheral device; in the instruction, ADD A to B, A and B are the operands, and ADD is the operation code), in order to employ register-to-register instructions. CISC compilers use an ideal addressing mode and the shortest instruction format to add operands in memory, and make repeated memory accesses in a calculation. RISC compilers however, prefer to use LOAD and STORE instructions to access memory so that operands are not implicitly discarded after being fetched, as in CISC memory-to-memory architecture.

Notwithstanding the above, differences between RISC and CISC processors have blurred over time. As the time per program is equal to the instructions per program times the cycles per instruction and the time per cycle, in modern CPU ISAs, many instructions, no matter how rarely-used, are often included, if the cycle-time can be made small and the hardware and/or control store exists for implementing the instructions. Thus the number of instructions is not reduced in modern CPUs; only the cycle time is reduced. Further, even more designs with fanciful acronyms have appeared, including NISC (No Instruction Set Computer) and WISC (Writable Instruction Set Computer) for embedded processors that have rewritable microcode. There are ideas for processors that are reconfigurable, even reconfigurable during runtime, in FPGA logic. An example of a recent processor that provides direct support for the Java language, in hardware, is U.S. Pat. No. 6,317,872, incorporated herein by its entirety. An example of the use of microcode as the executable language on an embedded processor is in public use from the assignee of the present invention in a GPS product placed in public use around 1997.

However, ultimately a microprocessor ISA is useful only if it enables one to achieve suitable performance for the task at hand. What is not found in the prior art is a system and method to scale network infrastructure to enable small but very capable fully network connected digital processing systems, using a processor that is fast and energy efficient. The present invention addresses these concerns.

### SUMMARY OF THE INVENTION

Accordingly, the present invention is directed to a processing device, such as a network microprocessor that provides fast performance with a small footprint and low power consumption.

The network processor of the present invention includes one or more cores, which are minimal but complete computing units, each having microcoded architecture, employing lines of non-opcode-oriented, fully decoded microcode (microinstructions), that do not require an instruction decoder for execution, in a stored microprogram (which may be loaded from external memory), and other functional units for data processing and manipulation, to give VLIW-type performance at reduced power consumption.

The network processor core of the present invention employs microcode for the native execution language, with preferably no opcodes, but rather employing microprogrammable microcode instructions. The microcode instructions of the core are very efficient, fine grained logic and provide control for data manipulation capability, including conditional branching. One line of microcode in the core can be equal or even superior to specialized opcodes assembled by a typical assembly language assembler. The use of more complex microcode instructions provides a form of inherent parallelism, providing multiple simultaneous data manipulation operations per line of microcode. In an optimal case, the microcode of the present invention can be sometimes equivalent to multiple lines of High Level Language (HLL) code.

A variation of the network processor of the present invention may use a 24 bit integer with hardwired (math and trigonometric) functions; and data path widths and arithmetic capabilities sized to solve a particular embedded processor application.

As explained further herein, the core has “test select” control logic in the form of flip flops to control flow decisions.

The network processor of the present invention may be implemented as a network router solution that is smaller than conventional network processors, making it possible to construct “real” networks (including IP services, for example) in a miniature size and reduced power footprint. The present invention utilizes a core architecture comprised of a programmable microcoded sequencer (a microsequencer) to implement state management and control, and a data manipulation subsystem controlled by fully decoded microinstructions.

The architecture of the present invention, though preferably an ASIC device comprised of a set of programmable building blocks, may be implemented in any combination of hardware and/or software such as a Programmable Logic Device (PLD).

The sum total of all of the above advantages, as well as the numerous other advantages disclosed and inherent from the invention described herein, creates an improvement over prior techniques.

The above described and many other features and attendant advantages of the present invention will become apparent from a consideration of the following detailed description when considered in conjunction with the accompanying drawings.

### BRIEF DESCRIPTION OF THE DRAWINGS

Detailed description of preferred embodiments of the invention will be made with reference to the accompanying drawings. Disclosed herein is a detailed description of the best presently known mode of carrying out the invention. This description is not to be taken in a limiting sense, but is made merely for the purpose of illustrating the general principles of the invention. The section titles and overall organization of the present detailed description are for the purpose of convenience only and are not intended to limit the present invention.

FIG. 1 is a schematic of a prior art network processor, the Intel IXP1200.

FIG. 2 shows a block diagram of a processing device in accordance with an embodiment of the present invention.

FIG. 3 shows a small footprint, low power network processor according to an embodiment of the present invention.

It should be understood that one skilled in the art may, using the teachings of the present invention, vary embodiments shown in the drawings without departing from the spirit of the invention herein. In the figures, elements with like numbered reference numbers in different figures indicate the presence of previously defined identical elements.

### DETAILED DESCRIPTION OF THE INVENTION

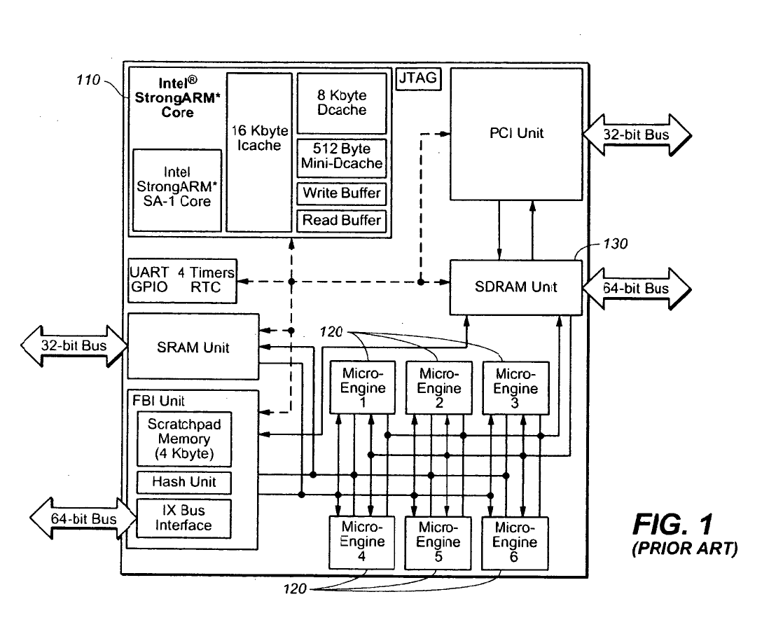

FIG. 1 is a schematic of a prior art network processor, the Intel IXP1200. This prior art network processor utilizes numerous opcodes in its microarchitecture. The Intel IXP network processor family is a microcoded processor family, where each processor has a relatively small microcode memory (thousands of lines of microcode). The microcode may be fixed (ROM) or variable (RAM), but is typically configured in some initialization phase, and remains in place for the duration of the computing mission. An Intel StrongARM Core 110 is a control unit that performs logical operations and several microengines 120 that may be cores from the StrongARM family provide switching, with on-board SRAM 130. In a programmable microprocessor, the complete macroinstruction is executed by generating an appropriately timed sequence of groups of control signals, with the execution termed the microoperation.

While the microoperations in the Intel IXP are ultimately implemented by hardware, they are generated through microinstructions in the form of operational codes which require more time to execute than a fully decoded microcoded control signal for use as a microoperation. Conversely, the network processor of the present invention does not require opcodes.

Thus while the use of microcoded network processors for implementation of functions such as network routing is well known in the art, such as in the Intel IXP1200 family, one novelty of the processing device of the present invention is in its architecture, and particularly, its use of fully decoded microcoded controls (fully decoded microinstructions), rather than in the use of extensive opcodes like a typical network microprocessor (Intel IXP 1200). The fully decoded microcode of the present invention enables a rich set of controls and data manipulation capabilities. A key benefit of fully decoded microcode is that it enables an extremely simple microarchitecture. In an embodiment of the invention, a processing device of the present invention may have the capability to manage a subnetwork with up to 16,000 nodes, and may be implemented in as few as 10,000 to 20,000 gates and 132 k bytes of RAM. In a 90 nm CMOS process, this may only require approximately 1.45 mm² of chip area and operate on nominally 4 milliwatts (mW) at 100 MHz.

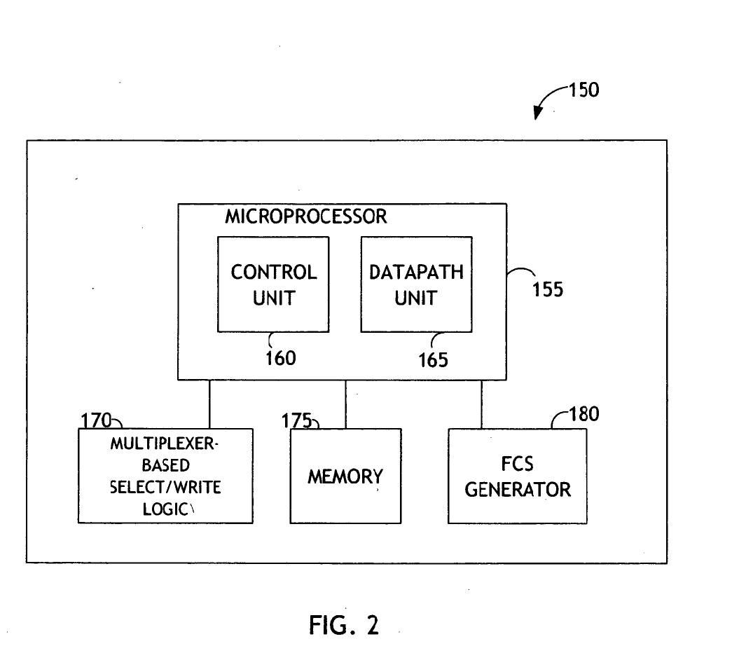

Referring to FIG. 2, a block diagram of a processing device 150 in accordance with an embodiment of the present invention is shown. Processing device 150 may include a microprocessor 155. Microprocessor 155 may include a control unit 160 and a datapath unit 165 whereby the datapath unit 165 may be directed by the control unit 160. The control unit 160 may include a microcoded control unit and may include a control store which stores a microprogram. Control unit 160 may further include a microsequencer to execute the microprogram. Processing device 150 may further include multiplexer-based register select/write logic 170, a memory 175, and a Frame Checking Sequence Generator 180 operatively connected to the microprocessor 155. Datapath unit 165 may include at least one multiport register, arithmetic logic unit (ALU), memory such as random access memory (RAM) and data and address interface for main memory 170. Advantageously, microprogram may include non-opcode-oriented, fully decoded microinstructions that do not require an instruction decoder for execution. Additionally, processing device 150 may be implemented with a high performance to size and power density for use in applications such as Software Defined Radio (SDR) mesh topology.

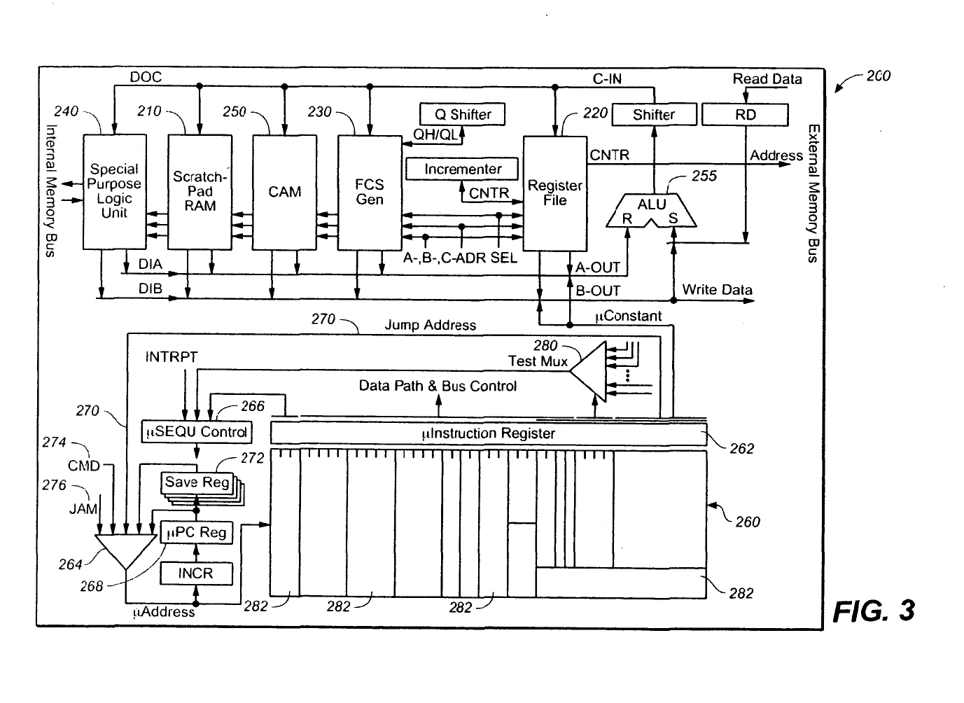

Referring to FIG. 3 a small footprint, low power network processor 200 according to an embodiment of the present invention is shown. Network processor 200 may be one implementation of processing device 150 of FIG. 1 according to an embodiment of the invention. The architecture of a small footprint, low power network processor 200 may be termed a core architecture, which can be implemented in a variety of different ways, typically as an embedded microprocessor in a network, as a network processor (explained further herein).

The core architecture of the present invention saves power by performing various computing functions in a novel way, thereby using the minimum number of gate switch operations (‘toggles’); these electrical operations consume energy in CMOS integrated circuits. Each gate switch operation requires power; consequently, reduction of the number of gate switch operations provided in the core architecture of the present invention reduces power consumption. Broadly, the core architecture (hereinafter “core”) saves energy when compared to prior art architecture in a plurality of ways. First, by utilizing a non-opcode oriented, fully decoded microcode (fully decoded microinstructions) as the native execution language in a microcoded control unit, generated by either manual or automated means (thus an execution instruction decoder is not required). Second, by utilizing multiplexer-based register select/write logic. Third, by utilizing a small number of gates so that the toggles are kept low; and fourth, using a predetermined, fixed microarchitecture as the execution environment, which enables the use of a hardwired ASIC implementation rather than an FPGA implementation.

Thus, to save energy, in a preferred embodiment of the present invention, first fully decoded microcode (fully decoded microinstructions) are used for the native execution language, thereby reducing the numerous instructions needed in the decoding stage of a classic RISC based microprocessor. Fully decoded microinstructions may include fully decoded microcoded control signals and/or data. It is contemplated that fully decoded microinstructions do not require compiling or decompiling at execution time, reducing latency of execution of the microinstructions and power consumption.

By way of example and not of limitation, if a fully decoded microinstruction for taking the cosine of a floating point number X, suitable hardware in the microcode would be able to compute the cosine of the number, to a predetermined degree of accuracy (e.g. using a power series comprising Taylor's formula), when presented with a suitable machine language version instruction of “COSINE X”, rather than have to parse and decode the instruction “COSINE” into a series of shorter instructions, such as a series of instructions for multiplications, divisions, additions, subtractions, and moving data into and out of registers and memory, and the like, using a decoding logic state, as in the prior art, e.g. with RISC microprocessors. This reduces the number of gates required to support execution of the instruction which reduces power consumption.

The present invention contemplates, and those skilled in the art will appreciate, that the core architecture of the present invention is preferably capable of processing any machine readable instruction. The core instructions may be 4 byte words and may be fixed or variable in length.

Examples of fully decoded instructions include categories such as: moving—to set a register (in the CPU itself) to a fixed constant value; to move data from a memory location to a register; to read and write data from hardware devices; computing—to add, subtract, multiply, or divide the values of two registers, placing the result in a register; to perform bitwise operations, taking the conjunction/disjunction (and/or) of corresponding bits in a pair of registers, or the negation of each bit in a register; to compare two values in registers; and, affecting program flow, to jump to another location in the program and execute instructions there; to jump to another location if a certain condition holds; to jump to another location, but save the location of the next instruction as a point to return to (e.g. a call). Other instructions include: saving many registers on the stack at once; moving large blocks of memory; complex and/or floating-point arithmetic (e.g., sine, cosine, square root); performing an atomic test-and-set instruction; instructions that combine ALU with an operand from memory rather than a register.

An additional embodiment of the present invention, for reducing power consumption, as provided by the core architecture, as disclosed herein, is the use of multiplexer-based registers with select/write logic for reducing gate count and energy consumption (FIG. 3).

The network processor of the present invention may be implemented in a small hand-held device. For example, with about 10,000 gates, with 32 bit on-chip microprogram control storage (basic 1K word RAM, extensible to 64K words and beyond), the network processor may be implemented in an area of approximately 1.45 mm². Likewise, in a preferred embodiment, the present invention configured in a 90 nm CMOS ASIC process will utilize approximately 6 nW/gate/MHz (typical process performance) with an approximate 500 to 1000 MHz maximum core clock speed (i.e., 10000 gates*6 nW/gate/Mhz*⅛ [statistical toggle/clock]=0.75 mW/MHz logic). Providing an improvement over the prior art with a presently calculated power consumption (operating at 1.0 GHz) of approximately 7.5 mW (with less than approximately 10 mW preferred). Computational performance is also enhanced whereby each line of microcode may perform on the order of 2× per line of assembly code or greater efficiency.

As an example, current Industry State of the Art Computation Efficiency is illustrated in the following table:

| | | | | | pJ./Instr. |
|---|---|---|---|---|---|
| Processor | Performance | Power | | MIPS/Watt | (picoJ) |
| PowerPC 440GX | 1000 MIPS | 2.5 | W | 400 | 2500 |
| ARM10 | 400 MIPS | 90 | mW | 4400 | 228 |
| core | 1000 MIPS | 7.5 | mW | 133000 | 7.5 |

Additionally, the network processor of the present invention requires reduced core energy consumption since, as an aspect of the invention, a predetermined, fixed microarchitecture is used as the execution environment. This structure allows for hard ASIC implementation rather than the more flexible, but power hungry, FPGA implementations of the prior art. In the present invention, only a small logic footprint is required where data paths are sized to provide communication needs and power consumption reductions. A 32 bit internal bus utilizing a 24 bit integer or the like may be utilized. Further, control may be utilized with fully decoded microcode tightly coupled to the data manipulation logic. In addition, the core is preferably designed with, for example, simple logic paths so as to enable register clock gating with most data manipulation logic comprised of data selectors or multiplexers which have low gate toggle statistics. Known prior art processor optimization techniques may also be employed where mesh size and bandwidth are necessary and power consumption is less critical, for example, pipeline processing, branch prediction and speculative execution. Presently, a single physical memory providing a minimal execution environment is preferred. On-chip execution memory as opposed to cache management hardware is preferred. Thus, contrary to the prior art, the present invention teaches a non-high-speed optimized architecture (NHSOA) having a core without pipeline processing, branch prediction, speculative execution, multiple memory space (whether physical or equivalent to a single memory) or an on-chip execution memory.

In FIG. 3, the core 200 is illustrated with hardware modules comprising the control unit directing a datapath unit. The control unit controls the steps taken by the datapath unit during the datapath's execution of an instruction (any or all of machine instructions, microinstructions or macroinstructions), including state management and control, and in a preferred embodiment the control unit (FIG. 3) is a microcoded control unit implemented as a microprogram in a control store, having a programmable microsequencer to execute the microprogram, with the microprogram comprising fully decoded microinstructions (e.g. with no need to decode these microinstructions in the control store). The datapath unit (or data manipulation subsystem) is controlled by the control unit and includes all circuits and functionality needed to execute the control unit instructions. The datapath unit includes such hardware as registers, function units such as ALUs (arithmetic logic units), shifters, interface units for main memory and I/O (data and address interface), RAM, including scratchpad RAM, internal busses, an instruction latch, an arithmetic-logic unit, an incrementer, a shift/rotate logic unit, and a multi-port register file. Hence, the data-path section provides the data manipulation and processing functions required to execute the instruction set. Scratchpad RAM 210 is a memory cache reserved for direct and private usage by the CPU.

The register file 220 may have a multiport design to achieve the parallelism needed for high execution speed and compact microcode. During every microcycle, file locations are output, and, at the end of the microcycle, file locations are written back. The register file may have inputs for a plurality of stack registers, one or more counters, shift registers, general purpose registers, and architectural pointers. Architectural pointers may include pointers for the code-environment pointer, program counter, the data environment, local environment, top of the stack, all for dynamically allocating and identifying variables and parameters on the stack. Addressing the data and instructions may reside conceptually on different memories, or alternatively, the memories may be combined in a unified cache.

A Frame Checking Sequence (FCS) Generator block 230 may be utilized to calculate CRC (cyclical redundancy checking) across any transmitted data. A special purpose logic unit 240 may be employed to enhance network security or the like. A CAM 250 (Content Addressable Memory) allows for very fast table lookup, useful for network routing, and a preferred environment for the core. Internal and external memory buses exist, as labeled in FIG. 3, for connection of the microprocessor control and datapath units to internal and external memory.

A 16-bit ALU block 255 provides addition, logical operations, and indications of sign, all-zero, carry, and over-flow status. The R and S inputs to the ALU are fed from multiplexing logic in order to provide several source alternatives. Several formats are preferably included to support efficient multiplication and division algorithms.

An instruction latch receives microinstruction words from program memory for each fetch initiated. The incoming bytes are fully decoded microcode; the words are passed to the microcontroller to initiate instruction execution. Program constant (immediate) data is fed to the ALU as S source operands.

The function of the microsequencer 264, which can be controlled by the microsequencer controller 266 (FIG. 3) is to generate the IO-bit microaddress fed to the control-store ROM. At each microprogram step, the next microaddress is selected from one of the following sources:
1. The microprogram counter 268 (the register labeled “p PC REG” in FIG. 3) containing the address of the current microinstruction incremented by one;
2. 10-bit jump address 270 emanating from the field of the current microinstruction and allowing nonsequential access to the control store 268 (the line 274 labeled “JUMP ADDRESS” in FIG. 3);
3. A save register 272 previously loaded from the microprogram counter to establish the return linkage from a called microsubroutine;
4. The current fully decoded microinstruction word from line labeled “CMD” in FIG. 3, which is operatively connected to the microinstruction register 262 (labeled μINSTRUCTION REGISTER in FIG. 3) and/or receives microinstructions from a stored microprogram that is loaded from external memory to the core chip (a command line may be provided and may be either external to the device or attached to the microinstruction register 262; or
5. Jam logic 276 (from line labeled “JAM” in FIG. 3) for generating the starting microaddress for initialization, interrupt servicing, and execution.

The selection of the next microinstruction to be executed is in some cases, conditional on the state of a particular status line. To determine this state, preferably eight status lines are fed to the test multiplexer, shown in FIG. 3 as triangular shaped test multiplexer 280. Conditional and unconditional JUMP, MAP, CALL and RETURN operations can then be selected by the microprogram.

Clock logic preferably includes oscillator circuitry and divide-by n logic to produce the necessary internal timing signals. The clock logic may advantageously allow pauses to be inserted as required during memory accesses. Intertwined with the clock logic is bus-acquisition and read/write control logic.

By way of example, the microcode-control-store ROM 260 may be configured as 1024 words, each 48 bits in length, conceptually shown in FIG. 3 by dividing the microinstruction register 262 into blocks 282. The 48-bit microinstruction word may then be divided into subfields, as shown in FIG. 3. In an exemplary embodiment the format is “horizontal,” having minimum overlap in field definitions to allow maximum parallel operation in the data paths. A two pass microassembler may be used to translate symbolic microprogram source into object code. The ROM control store 260 may be replaced by an EPROM, EEPROM or flash memory.

Testability of the core is a high priority in the microarchitecture development. Key features include, for example, (1) shift capability of the microinstruction register and external pins for serial I/O and control (allows test equipment to shift out and verify the entire ROM contents); (2) special microinstructions may be serially loaded into the register and executed (micro diagnostics can be performed for debug and testing); (3) ability to repeatedly execute a single microinstruction at high speed (allows oscilloscope verification).

The power of the core's testability features allows thorough verification of its major elements. Separation of the address and data buses is also advantageous in this regard. High visibility and testability are achieved even for packaged parts.

The testing and design of the core may be done with conventional ASIC design flow methodologies, that include design entry, logic synthesis, system partition, prelayout simulation, floorplanning, placement and routing, circuit extraction and postlayout simulation, using conventional software tools, as is known per se in the art.

It is contemplated that the network processor of the present invention may be suitable for operation in a variety of applications which require a small form factor, low-power processing device. For example, network processor may be suitable for applications such as Software Defined Radio (SDR) mesh topology. However, the network processor of the present invention may be implemented in an embedded system for other types of applications, including data retrieval, communication and storage.

It is intended that the scope of the present invention extends to all such modifications and/or additions and that the scope of the present invention is limited solely by the claims set forth below.

1. A processing device, comprising:
a microprocessor comprising a control unit and a datapath unit, said control unit directing said datapath unit;
said control unit comprising a microcoded control unit comprising a control store and having a microprogram in said control store, with the microprogram comprising fully decoded microinstructions.

2. The processing device according to claim 1, further comprising:
a plurality of multiplexer-based register select/write logic operatively connected to said microprocessor.

3. The processing device according to claim 1, wherein said microprocessor is an ASIC.

4. The processing device according to claim 3, wherein said ASIC has a microarchitecture that is a non-high-speed optimized architectural simplicity architecture.

5. The processing device according to claim 2, further comprising:
a programmable microsequencer in said control unit to execute said microprogram;
memory coupled to the microprocessor that is external to said microprocessor;
said datapath unit comprising, operatively connected to one another, at least one multiport register, ALU, data and address interface for said main memory, and RAM on said microprocessor; and
a Frame Checking Sequence (FCS) Generator block operatively connected to said microprocessor to calculate CRC for any data transmitted by said microprocessor.

6. The processing device according to claim 5, wherein said microprocessor consumes less than 10 mW power operating at a frequency of 1.0 GHz.

7. A processing device, comprising:
a microprocessor comprising a control unit and a datapath unit, said control unit directing said datapath unit;
said control unit comprising microcoded control unit comprising a control store and having a microprogram in said control store, said control unit further comprising a microsequencer for executing said microprogram, wherein the microprogram includes fully decoded microinstructions.

8. The processing device according to claim 7, further comprising:
a plurality of multiplexer-based register select/write logic operatively connected to said microprocessor.

9. The processing device according to claim 7, wherein said microprocessor is an ASIC.

10. The processing device according to claim 9, wherein said ASIC has a microarchitecture that is a non-high-speed optimized architectural simplicity architecture.

11. The processing device according to claim 7, further comprising:
memory coupled to the microprocessor that is external to said microprocessor;
said datapath unit comprising, operatively connected to one another, at least one multiport register, ALU, data and address interface for said memory, and RAM on said microprocessor; and
a Frame Checking Sequence (FCS) Generator block operatively connected to said microprocessor to calculate CRC for any data transmitted by said microprocessor.

12. The processing device according to claim 11, wherein said microprocessor consumes less than 10 mW power operating at a frequency of 1.0 GHz.

13. A system for processing, comprising:
a control unit;
a datapath unit, which is directed by the control unit; and
a microprogram;
wherein the control unit includes a microcoded control unit, the control unit includes a control store for storing the microprogram, the control unit includes a microsequencer for executing the microprogram, and the microprogram comprises fully decoded instructions.

14. The system of claim 13, wherein the control unit and datapath unit are incorporated in a network processor implemented in a hand-held device.

15. The system of claim 13, wherein the control unit and the datapath unit are incorporated into a microprocessor.

16. The system of claim 13, wherein the system further comprises a plurality of multiplexer-based register select/write logic.

17. The system of claim 13, wherein the control unit and the datapath unit are incorporated into one selected from an ASIC and a Programmable Logic Device (PLD).

18. The system of claim 17, wherein the ASIC has an architecture that is a non-high-speed optimized architectural simplicity architecture.

19. The system of claim 15, further comprising:
a memory which is external to the microprocessor; and
a Frame Checking Sequence (FCS) Generator block for calculating CRC for any data transmitted by the microprocessor;
wherein the datapath unit further comprises at least one multiport register, an ALU, a data and address interface for the memory external to the microprocessor, and RAM.

20. The system of claim 15, wherein the microprocessor consumes less than 10 mW power when operating at a frequency of 1.0 GHz.
